(19) United States
(12) Patent Application Publication
(10) Pub. No.: US 2009/0056182 A1
(43) Pub. Date: Mar. 5, 2009

(54) BILLBOARD

(75) Inventors: CHAO-YU HUNG, Chu-Nan (TW); CHIH-MING LAI, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 11/964,810

(22) Filed: Dec. 27, 2007

(30) Foreign Application Priority Data
Sep. 4, 2007 (CN) 200710201579.8

(51) Int. Cl. G09F 9/30; G03B 25/02

(52) U.S. Cl. 40/454; 40/463

(57) ABSTRACT

An billboard (10) includes a substrate (11), a lens array (12) and at least one light source (13). The substrate has two opposite surfaces. A plurality of pattern units formed on one surface of the substrate or formed in the substrate. Each pattern unit includes a plurality of pattern cells for being selectively combined to form at least one independent image. The lens array corresponding to the pattern units is arranged on one surface of the substrate. The lens array is configured for displaying the at least one independent image. The lens array includes a plurality of cylindrical stripe-like lenses. The cylindrical stripe-like lenses substantially extend parallel to each other. At least one light source disposed facing to the other surface of the substrate configured for emitting light rays towards the substrate.

### CROSS-REFERENCE TO RELATED APPLICATIONS

This application claims all benefits accruing under 35 U.S.C. §119 from China Patent Application No. 200710201579.8, filed on Sep. 4, 2007 in the China Intellectual Property Office, the disclosure of which is incorporated herein by reference.

### BACKGROUND

1. Technical Field

The present invention relates to advertising billboard devices and, particularly, to billboards capable of multi-image presentation.

2. Description of the Related Art

Billboards are used to display various messages typically consisting of a combination of text and graphics. Traditionally, the message has been provided by way of a single fixed sheet that is pasted to a backing. This traditional approach requires the use of an external tool to change the displayed message. Electronic billboards provide the advantage in that the display message can be conveniently changed without the use of an external tool. While the display message of electronic billboards can easily be changed, they are difficult to manage and often require significant support resources to coordinate billboard content.

What is needed, therefore, is a new billboard that can overcome the above-described shortcomings.

### SUMMARY

The present invention relates to a billboard. The billboard includes a substrate, a lens array and at least one light source. A plurality of pattern units can be provided at a first side of the substrate. Each of the pattern units includes a plurality of pattern cells for being selectively combined to form at least one independent image. The lens array corresponding to the pattern units is arranged on one surface of the substrate at the first side thereof. The lens array is configured for displaying the at least one independent image. The lens array includes a plurality of cylindrical stripe-like lenses. The cylindrical stripe-like lenses extending substantially parallel to each other. At least one light source is disposed at an opposite second side of the substrate and facing to the other surface of the substrate configured for emitting light rays towards the substrate.

The present invention relates to another billboard. The billboard includes a substrate, a lens array and at least one light source. A plurality of pattern units can be provided at a first surface of the substrate. Each of the pattern units includes a plurality of pattern cells for being selectively combined to form at least one independent image. The lens array corresponding to the pattern units is configured for displaying the at least one independent image. The lens array includes a plurality of cylindrical stripe-like lenses arranged in rows and columns. At least one light source is disposed facing to an opposite second surface of the substrate configured for emitting light rays towards the substrate.

The present invention further relates to another billboard. The billboard includes a substrate, a lens array and at least one light source. The substrate has two opposite surfaces. A plurality of pattern units can be formed on one surface of the substrate or formed in the substrate. Each pattern unit includes a plurality of pattern cells for being selectively combined to form at least one independent image. The lens array corresponding to the pattern units is arranged on one surface of the substrate. The lens array is configured for displaying the at least one independent image. The lens array includes a plurality of cylindrical stripe-like lenses. The cylindrical stripe-like lenses substantially extend parallel to each other. A wedge-shaped light guide plate is disposed facing the other surface of the substrate. The wedge-shaped light guide plate has an incident surface. The at least one light source is disposed facing the incident surface of the wedge-shaped light guide plate.

Other novel features will become more apparent from the following detailed description when taken in conjunction with the accompanying drawings.

### BRIEF DESCRIPTION OF THE DRAWINGS

Many aspects of the present billboard can be better understood with reference to the following drawings. The components in the drawings are not necessarily drawn to scale, the emphasis instead being placed upon clearly illustrating the principles of the present billboard. Moreover, in the drawings, like reference numerals designate corresponding parts.

FIG. 1 is a schematic view of a billboard, in accordance with a first embodiment.

FIG. 2 is a cross-sectional view of the billboard taken along the line II-II of FIG. 1.

FIG. 3 is a schematic view of a lens in FIG. 1.

FIG. 4 is an explanatory view for explaining the operation of two-image presentation of the billboard.

FIG. 5 is an explanatory view for explaining the operation of three-image presentation of the billboard.

FIG. 6 is a schematic view of a billboard, in accordance with a second embodiment.

FIG. 7 is a schematic view of a billboard, in accordance with a third embodiment.

### DETAILED DESCRIPTION OF THE INVENTION

Reference will now be made to the drawings to describe in detail at least one preferred embodiment of the present billboard.

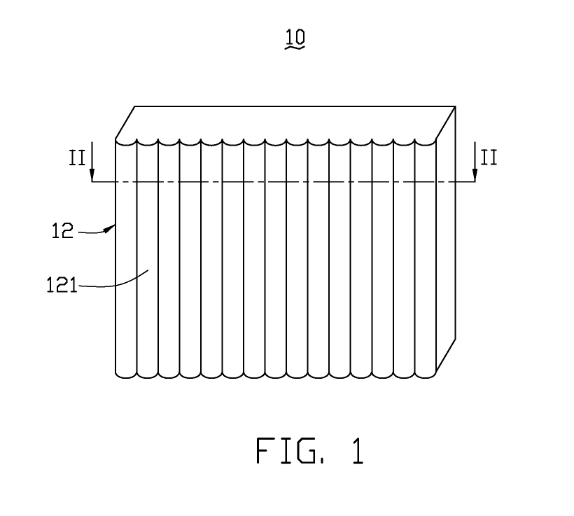

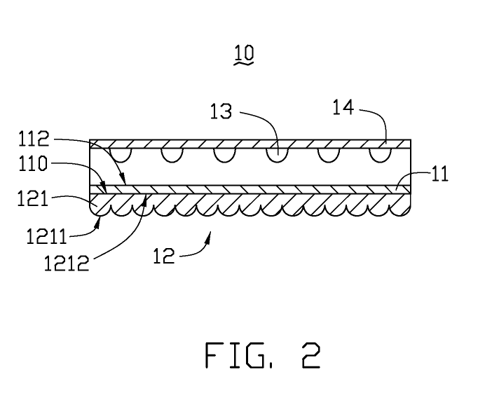

Referring to FIGS. 1 and 2, a billboard 10, according to a first present embodiment, includes a transparent substrate 11, a lens array 12, and at least one light source 13.

The transparent substrate 11 includes a first surface 110 and a second surface 112 opposite to the first surface 110. Referring to FIG. 2, in the present embodiment, the lens array 12 is arranged on the first surface 110 of the substrate 11, and the light sources 13 are located on the second surface 112 of the substrate 11, i.e., the substrate 11 is located between the lens array 12 and the light sources 13. In the present embodiment, the light sources 13 are electrically and securely connected with a circuit board 14.

The light sources 13, in the present embodiment, are light emitted diodes (LED). The light sources can also be other illuminating devices, such as cold cathode fluorescent lamp (CCFL), etc.

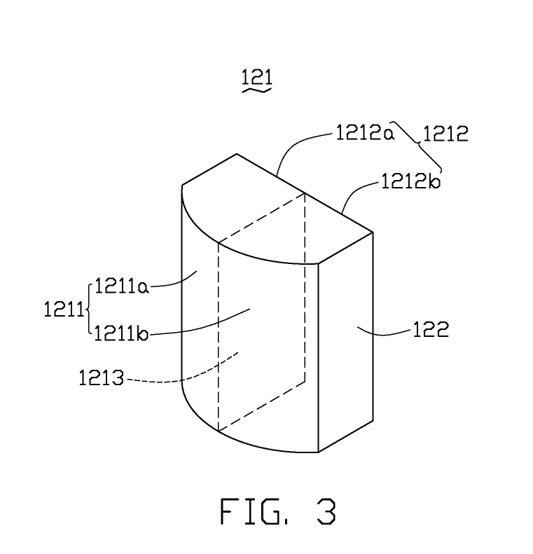

The lens array 12 includes a plurality of cylindrical stripe-like lenses 121 arranged in a row or a column. The cylindrical stripe-like lenses 121 are parallel to each other. Referring to FIG. 3, each cylindrical lens 121 includes a lens body 122. The lens body 122 has an incident surface 1212 and a light emitting surface 1211 opposite to the incident surface 1212. The incident surface 1212 is a plane surface, and the light emitting surface 1211 is a cylindrical surface. The incident surface 1212 of lens body 122 is opposite to the first surface 110 of the substrate 11.

Referring to FIG. 3 again, a meridian plane 1213 perpendicular to the incident surface 1212 divides the light emitting surface 1212 into a first cylindrical surface 1212a and a second cylindrical surface 1212b, and divides the incident surface 1211 into a first part 1211a and a second part 1211b. The first cylindrical surface 1212a of each one of the cylindrical stripe-like lenses is spaced from each other by the second cylindrical surface 1212b.

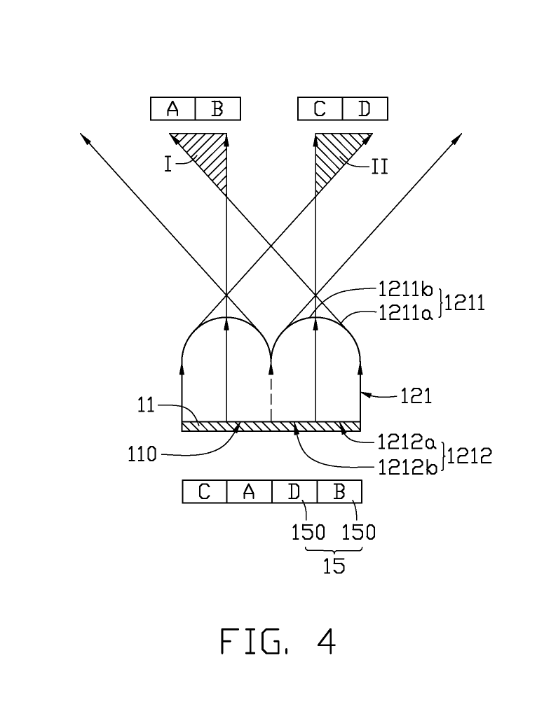

FIG. 4 is an explanatory view for illustrating the operation of two-image presentation of the billboard. In the present embodiment, a plurality of pattern units 15 corresponding to the lens array 12 is formed on the first surface 110 of the substrate 11. Each of the pattern units 15 can be divided into a plurality of pattern cells 150. The arrangement direction of the pattern cells 150 is perpendicular to the extending direction of the cylindrical lens 121. The plurality of pattern cells 150 can be selectively combined to form at least one independent image consisting of a combination of text and graphics. In alternative embodiments, the plurality of pattern units 15 can be formed on the second surface 112 of the substrate 11 or formed in the substrate 11.

Each pattern unit 15 on the first surface 110 of the substrate 11 can be divided into a plurality of pattern cells 150 (referring to FIG. 4). For example, in the present embodiment, a pattern unit 15 consists of the pattern cells “C” and “A”, and another pattern unit 15 consists of the pattern cells “D” and “B”. In the operation, referring to FIG. 2 and FIG. 4, the parallel light rays emitted from the light sources 13 are transmitted through the substrate 11 and illuminate the pattern cells “C”, “A”, “D”, and “B” on the first surface 110 of the substrate 11. The transmitted light rays incident on the incident surface 1212 of the lens body 122 and are refracted by the lens body 122 so that images of the patterns “A” and “B” are formed in the region I, and images of the “C” and “D” are formed in the region II. Different images can be observed from different position and different angle.

In alternative embodiments, the transparent substrate 11 can be a transparent film.

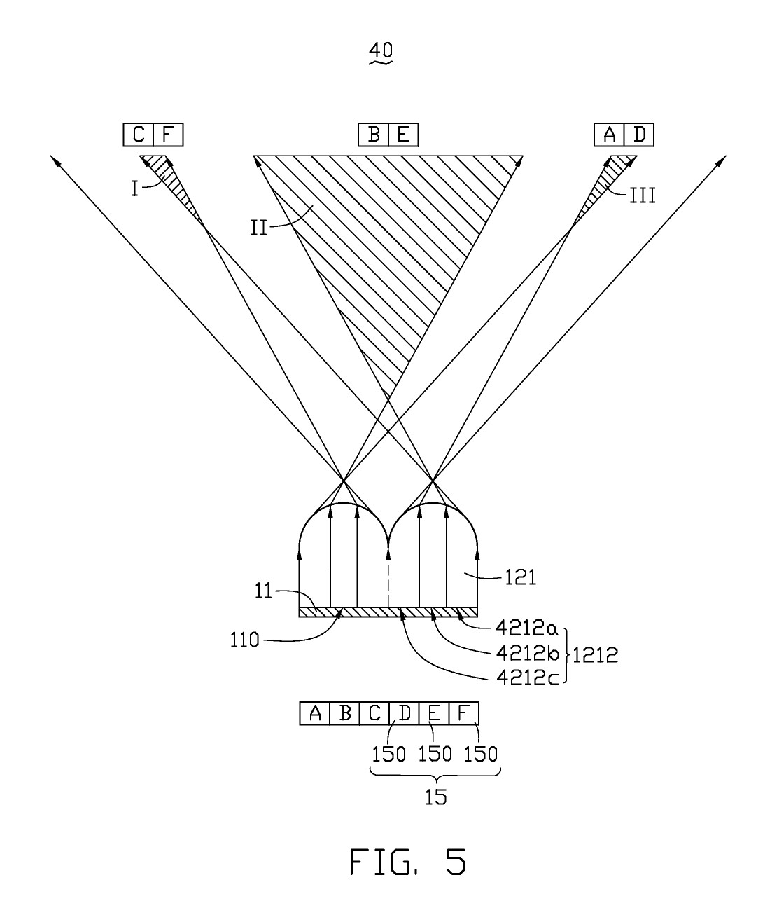

It can be understood that, the number of pattern cells 150, the pattern units 15 can be divided into, not limited to two, it also can be three, six, etc. For example, referring to FIG. 5, a pattern unit 15 consists of the pattern cells “A”, “B”, “C”, and another pattern unit 15 consists of the pattern cells “D”, “E”, “F”. The incident surface 1212 is divided into three equal-area parts 4212a, 4212b, and 4212c corresponding to the pattern cells 150. Images of the patterns “C” and “F” are formed in the region I, images of the patterns “B” and “E” are formed in the region II, and images of the patterns “A” and “D” are formed in the region III.

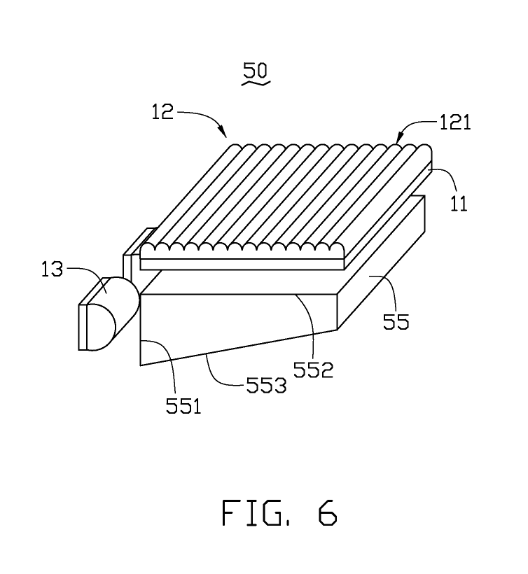

Referring to FIG. 6, a billboard 50, according to a second present embodiment, includes a transparent substrate 11, a lens array 12, and at least one light source 13. The structure of second embodiment is similar to that of the billboard 10 in the first embodiment. The difference is that, the billboard 50 further includes a wedge-shaped light guide plate 55. The light guide plate 55 includes a light emitting surface 552 on the top of the light guide plate 55, a bottom surface 553 on the bottom of the light guide plate 55, and an incident surface 551 located between the light emitting surface 552 and the bottom surface 553. The light emitting surface 552 is opposite to the transparent substrate 11.

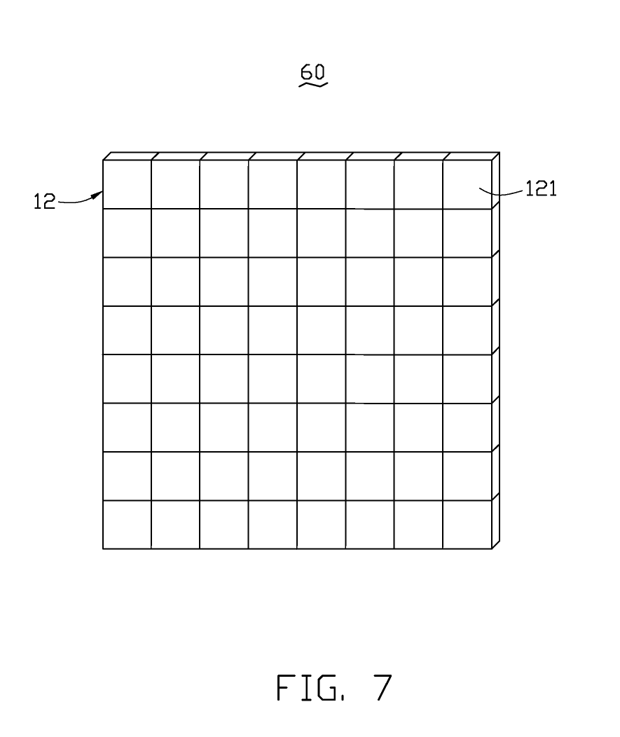

Referring to FIG. 7, a billboard 60, according to a third present embodiment is illustrated. The structure of third embodiment is similar to that of the billboard 10 in the first embodiment. The difference is that, the lens array 12 of the billboard 60 includes a plurality of cylindrical stripe-like lenses 121 arranged in rows and columns. The cylindrical stripe-like lenses 121 can be arranged in same direction with each other. The cylindrical stripe-like lenses 121 can also be arranged in different directions with each other. In the present embodiment, the cylindrical stripe-like lenses 121 are arranged in a same direction with each other.

The billboards described in the embodiments are capable of multi-image presentation. Through the lens array 12, a plurality of patterns selectively combined by the plurality of pattern units on the substrate 11 can be observed from different position and different angle.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Furthermore, this application is intended to cover such departures from the present disclosure as come within known or customary practice in the art to which the invention pertains and which fall within the limits of the appended claims or equivalents thereof.

What is claimed is:

1. A billboard, comprising:
a substrate;
a plurality of pattern units provided at a first side of the substrate, each of the pattern units comprising a plurality of pattern cells for being selectively combined to form at least one independent image;
a lens array corresponding to the pattern units arranged on one surface of the substrate at the first side thereof, the lens array being configured for displaying the at least one independent image, wherein the lens array comprises a plurality of cylindrical stripe-like lenses, the cylindrical stripe-like lenses extending substantially parallel to each other; and
at least one light source disposed at an opposite second side of the substrate and facing to the other surface of the substrate configured for emitting light rays towards the substrate.

2. The billboard as claimed in claim 1, wherein each of the cylindrical stripe-like lenses includes a lens body, and the lens body has an incident surface and light emitting surface opposite to the incident surface.

3. The billboard as claimed in claim 2, wherein the incident surface of the lens body is a plane surface, and the light emitting surface of the lens body is a cylindrical surface.

4. The billboard as claimed in claim 1, wherein each of the pattern units comprises two equal-area pattern cells arranged perpendicular to the extending direction of the cylindrical stripe-like lenses.

5. The billboard as claimed in claim 1, wherein each of the pattern units comprises three equal-area pattern cells arranged perpendicular to the extending direction of the cylindrical stripe-like lenses.

6. The billboard as claimed in claim 1, wherein the at least one light source includes a light emitting diode.

7. A billboard, comprising:
a substrate having two opposite surfaces;
a plurality of pattern units formed on one surface of the substrate or formed in the substrate, each pattern unit comprising a plurality of pattern cells for being selectively combined to form at least one independent image;
a lens array corresponding to the pattern units arranged on one surface of the substrate, the lens array being configured for displaying the at least one independent image, wherein the lens array comprises a plurality of cylindrical stripe-like lenses, the cylindrical stripe-like lenses substantially parallel to each other;
a wedge-shaped light guide plate disposed facing the other surface of the substrate, the wedge-shaped light guide plate having an incident surface; and
at least one light source disposed facing the incident surface of the wedge-shaped light guide plate.

8. A billboard, comprising:
a substrate;
a plurality of pattern units provided at a first surface of the substrate, each of the pattern units comprising a plurality of pattern cells for being selectively combined to form at least one independent image;
a lens array corresponding to the pattern units, the lens array being configured for displaying the at least one independent image, wherein the lens array comprises a plurality of cylindrical stripe-like lenses arranged in rows and columns; and
at least one light source disposed facing to an opposite second surface of the substrate configured for emitting light rays towards the substrate.

9. The billboard as claimed in claim 8, wherein the cylindrical stripe-like lenses are oriented in a same direction.

10. The billboard as claimed in claim 8, wherein the cylindrical stripe-like lenses are oriented in different directions.
